(19) United States
(12) Patent Application Publication
(10) Pub. No.: US 2019/0320593 A1
(43) Pub. Date: Oct. 24, 2019

(54) PLANT SUPPORT SYSTEM

(71) Applicants: Franz Josef HASENEDER, Erding (DE); MARVIN NOÉL RIMMELE, Imburg (DE)

(72) Inventor: Franz Josef HASENEDER, Erding (DE)

(21) Appl. No.: 16/391,598

(22) Filed: Apr. 23, 2019

(30) Foreign Application Priority Data
Apr. 24, 2018 (DE) 10 2018 109 827.8
Apr. 18, 2019 (EP) 19170215.8

(51) Int. Cl. A01G 9/12

(52) U.S. Cl. CPC A01G 9/12

(57) ABSTRACT

The present invention relates to a plant support system (100), comprising at least a first stake (1a) and a second stake (1b) for supporting at least one plant (27) thereto, as well as a releasable connecting element (3a) for connecting the two stakes (1a, 1b) to each other, wherein the connecting element (3a) is movable along the first stake (1a) and/or along the second stake (1b), so that at least one of the two stakes (1a, 1b) may be adapted to a plant growth.

The present invention relates to a plant support system having stakes that are movable or shiftable relative to each other for adapting the plant support system to a growth of the supported plant according to the preamble of claim 1. It further relates to a connecting element according to the preamble of claim 15.

Plant support systems are used exemplarily as so-called trellises formed as grid-like constructions to bring plants into a desired growth form. Likewise, plant support systems may be used as so-called climbing aids or trellises for climbing plants, so that these climbing plants can grow independently on the climbing aids. Plant support systems may be attached to a house wall or may be erected as a freestanding construction.

It is an object of the present invention to propose a further plant support system and a further connecting element.

The object according to the present invention may be achieved by a mounted plant support system, or by a set yet to be mounted of a plant support system with at least a first and a second stake and a, in particular releasable, connecting element for connecting the two stakes to each other, having the features of claim 1.

Thus, a plant support system that comprises at least a first stake and a second stake for supporting at least one plant thereon is proposed by the present invention. The plant support system further comprises a connecting element, in particular releasable, for connecting the two stakes with each other. The connecting element is movable along the first stake and/or along the second stake. Therethrough, the plant support system and/or at least one of the two stakes, in its orientation relative to the other stake, may be adapted to a plant growth.

The object according to the present invention may further be achieved by a connecting element according to the preamble of claim 15.

The connecting element may be designed to releasably fasten at least a first stake and to releasably fasten at least a second stake. Hence, the first and second stake are releasably connected to each other. This connection may serve the assembly of a plant support system according to the present invention or may be part thereof.

Exemplary embodiments according to the present invention may have one or several of the features mentioned below in any combination, unless the skilled person recognizes one or the specific combination as obviously technically impossible. Also the subject-matters of the dependent claims specify, respectively, exemplary embodiments according to the present invention.

In all of the statements mentioned above and in the following, the use of the expression “may be” or “may have” and so on, is to be understood synonymously with “preferably is” or “preferably has,” and so on, respectively, and is intended to illustrate exemplary embodiments according to the present invention.

“Top”, “bottom” and further spatial relations may, in doubt, be understood based on the arrangement in the figures.

Whenever alternatives with “and/or” are introduced herein, the person skilled in the art will understand the “or” contained therein as preferably “either or” and preferably not as “and”.

Whenever numerical words are mentioned herein, the person skilled in the art shall understand them as indications of numerical lower limits. Unless it leads the person skilled in the art to an evident contradiction, the person skilled in the art shall comprehend the specification for example of “one” as encompassing “at least one”. This understanding is also equally encompassed by the present invention as the interpretation that a numerical word, for example, “one” may alternatively mean “exactly one”, wherever this is evidently technically possible for the person skilled in the art. Both are encompassed by the present invention and apply herein to all used numerical words.

The embodiments mentioned herein are to be understood as purely exemplary embodiments according to the present invention which are not to be understood as limiting.

In some embodiments, a plant support system may be a grid-like device to which plants are fastened or on which e.g. climbing plants can grow independently. The plants may be crops (e.g. fruit tree shoots, grapevines), ornamental plants, (e.g.

roses) or other plants.

A plant support system for climbing plants may be referred to as a climbing aid or as a trellis. A plant support system, to which non-climbing plants or their shoots may be fastened, e.g. tied, may be used to bring these non-climbing plants to grow in a desired growth direction, e.g. in that plant sections are tied to sections e.g. of the stakes. This type of plant support system may be referred to as trellis. A trellis can be attached to a house wall or used as a freestanding construction. Trellises may be made of wood, metal, wire or fiber composite materials, e.g. of glass fiber reinforced plastic, or may comprise one or any of several of these materials.

A stake of the plant support system may be an elongated object, a straight structural element or an elongated semi-finished product. A stake may be made of plastic, a composite material or other material, or may comprise at least one of these materials.

In some embodiments, the connecting element for connecting the two stakes with each other may be referred to as a functional element. The connecting element may be a clamp, a clip, a collar, a strap, a fastening ring, a fastening tape or the like. The connecting may be denoted as releasable fastening or as clamping.

In several embodiments, the connecting element is designed to be releasable or detachable from each stake that is connected to it during use. Thus, the connecting element may be detached or released from stakes to which it is connected. It may subsequently be then reconnected to other stakes elsewhere in the plant support system and used at this new location within the plant support system. In such embodiments, the connecting element may be denoted as a releasable connecting element. The detachability of the connecting element from the stakes is thus not to be understood only as a shiftability of the connecting element along one or more stakes. A releasable connecting element is rather optionally also detachable from the stakes.

In some embodiments, the connecting element comprises a clamping system for fastening, in particular releasably, the stakes to or on the connecting element in a form-closure and/or form-fit connection. A purely form-closure clamping system could for example compress the two stakes by a clip—against each other or each individually—so that the stakes can no longer be moved against each other due to a frictional resistance of the surface of the stakes. Furthermore, a rough surface of the stakes in this contact area may increase the frictional resistance and may be provided. The amount of the pressing force or the pressing pressure on the stakes, for example by a clamp or another connecting element, is also an important influencing factor in this embodiment, wherein the strength of the stakes, based on the stake material, plays an essential role.

A form-fit fastening could for example be done by pins, edges, steps or the like, which are fastened to the stakes, in particular releasably.

A connecting element could then be fastened by these pins, edges etc. in a form-closure connection so that the stakes are blocked against a movement or a shifting. Such pins, edges, etc. may be part of or associated with the connecting element.

A force-closure and form-fit fastening may combine the two variants described, for example by a clip which fastens the stakes against a movement or a shifting by a pressing force on a at least in sections force-closure fastening of the stakes with the clamps. This would have the advantage that on the one hand the pressing force can be chosen to be lower compared to a purely force-closure embodiment, and on the other hand, the form elements, i.e. for example the pins or edges, may be made smaller.

In some embodiments, the connecting element surrounds or encloses at least two stakes completely or at least areas thereof, e.g. along their circumference or parts thereof. This (surrounding or enclosing) may be by a partially corresponding form of the outer circumference of the stakes (or part thereof) in the form of the connecting element.

In some embodiments, the connecting element comprises two, e.g. disc-shaped, elements (in short: disc or discs).

In some embodiments, a profile or partial profile—purely exemplarily round profile—of the stakes may have a corresponding form or may be mapped as partial half shell shape(s) or half shell shape(s) in the connecting element.

Such partial or half shell shape or shapes may be designed as recesses or depressions in the connecting element or in each of its disc-shaped elements. The partial or half shell shape may be referred to also as groove or gutter.

In several embodiments, the partial or half shell shapes extend in a main extension plane of the connecting element or of its disc-shaped elements or parallel thereto.

In some embodiments, the partial or the half-shell shapes do not extend through a central area of the main extension plane of the disc-shaped element. The central area or middle area may be advantageously used in these embodiments to provide a through-bore or through-opening which may be utilized as described herein, for instance to receive a screw.

If the two surfaces of both the stakes and the corresponding or mapped form of the connecting element are smooth, the connecting element may be moved relatively easily, that is to say without much effort, along one of the connected stakes. This applies in the same way for moving a stake when the connecting element is fastened to the other stake or is not movable. In this case, an applied pressing force for fastening the stakes by a clamping system would have to be higher in relation to rough surfaces of the stakes and/or of the form of the connecting element. Rougher surfaces result in a higher frictional resistance and thus in a higher force to be applied in order to overcome this frictional resistance.

In some embodiments, the connecting element comprises two, e.g. disc-shaped, elements (in short: disc or discs), which, on their inner side—together and/or individually—at least partially map the outer profile of the stakes or have a receptacle thereto.

A disc may be a geometrical body which is usually many times wider and/or longer than it is high.

A disc may, in top view, be round or angular, e.g. rectangular or polygonal. A disc may comprise e.g. 10, 15 or more edges along its circumference. If the circumference has more than 10 edges, this would already be considered as a being round according to the present invention, in particular if the edges are equidistant from each other and/or have the same distance to a center of the disc.

A disc may comprise one radius or several radii, e.g. concentric radii.

A disc may have the outer contour of a cylinder. A disc may comprise a trapezoidal cross section and/or may form a layer of a cone.

The statements made herein about the disc-shaped elements may also apply for non-disc-shaped elements in any embodiments.

The statements made herein about a disc may also apply for components which are not wider in at least one direction of extent than they are high.

The preferably disc-shaped elements may thus each have one or several through-bores or through-openings, through which e.g. a screw-nut connection of another connecting device may be or will be inserted, respectively.

In some embodiments, at least one or both of the disc-shaped elements comprise only exactly one such through-bore or through-opening.

In several embodiments, only one connecting device is inserted through each of the two elements, in particular during use of the present invention.

In some embodiments, at least one or both of the disc-shaped elements comprise a through-bore or through-opening which lies centrally in the element, e.g. in a center or geometric center thereof.

In several embodiments, at least one or both of the disc-shaped elements comprise a through-bore or through opening which has no internal thread. Clamping both elements against each other by a screw and a nut may thereby be advantageously carried out by screwing without one of the two elements twisting relative to the other due to the rotational movement. A desired angle between the two stakes connected by the connecting element may thus initially be set loosely and is advantageously no longer adversely affected or changed by the screwing together of the two elements against each other. Not providing a thread may furthermore advantageously omit inserting or manufacturing a thread in the connecting element, manufactured e.g. by injection molding.

In some embodiments, after sufficiently releasing the clamping of the two stakes, the connecting element is movable along the first stake and/or along the second stake, in particular during use of the plant support system. In this, it may optionally also be possible to move the connecting element along a fixed (since it is for example held immovably relative to the house wall) first or second stake and to clamp again a desired path further along the stake.

The preferably disc-shaped elements may each be designed such that only one of them at least partially maps the outer profile of both stakes on its inner side, i.e. on the side facing the stake during use.

The stakes may be arranged in the disc, in particular even if it is standing, for example at different heights (the height may be referred to as the thickness of the disc) of the disc, so that both stakes may be fastened to each other by the connecting element in a vertical arrangement (with respect to the longitudinal direction of the stakes).

Optionally, two disc-shaped elements map the outer profile of the stakes each on its inner side at least partially. For example, a stake with a portion of its outer surface and a longitudinal section of the stake could be inserted into a disc-shaped element on the inner side thereof, so that the respective surfaces of the two stakes directly adjoin each other. In particular, at least one portion of the surface of the stake protrudes beyond the inner, preferably flat, surface of the disc-shaped element. If the two disc-shaped elements are subsequently placed against each other with their inner sides, then optionally a direct contact of the surfaces of the stakes is made, which stakes respectively protrude beyond the inner side of the respective disc-shaped element. If the two disc-shaped elements are further pressed against each other, the stakes are pressed into the mapped form of the discs and/or clamped against each other and thus are blocked or fastened against a longitudinal movement of the stakes within the connecting element.

In some embodiments, the connecting elements consists of two disc-shaped elements and a connecting device between the two, designed for instance as a screw or as exactly one screw, a screw with nut (with or without washers), a spring or the like.

In some embodiments, the connecting element comprises two identical disc-shaped elements. Two identical disc-shaped elements are geometrically identical, so that any two such disc-shaped elements or discs are used together or are fastenable by a connecting device, e.g. a clamping system. This is advantageous regarding both manufacturing and assembling the disc-shaped elements, since there is no need to manufacture and assemble an exactly related pair that consists of discs that are partially different from each other (which preferably saves an injection molding for each second element). The stake profiles and the clamping system must then be selected and/or constructed according to these identical disc-shaped elements.

In some embodiments, each inner side of the disc-shaped elements at least partially maps the outer profile (or portions of the circumference) of only one of the two stakes.

In several embodiments, the inner side has no protrusions that would project beyond a contact surface or a main contact surface between two disc-shaped elements. These designs may favor a rotatability of one element relative the other.

In some embodiments, the inner sides of the disc-shaped elements each correspondingly maps at least partially the outer profile of one of the two stakes, so that, respectively, one stake may be fastened force-fit against moving in longitudinal direction of the stake, by frictional connection for a force closure between an area of an inner side and an area of a stake surface. The frictional resistance depends, amongst others, on the surface roughness and the material of the respective friction pair, i.e. the stake and the disc-shaped element. Furthermore, the forced closure depends on the force to be applied, which is exerted on the disc-shaped elements.

In some embodiments, the stakes are elongated hollow bodies, which may be referred to as tubes or tubular stakes. The stakes may be, or may have, in particular tubular, round profiles and/or, in particular tubular rectangular profiles, each as cross-section profile. The stakes may have round profiles, rectangular profiles, triangular profiles, oval profiles or another form. The stakes used, e.g. the first and the second, may have identical or, e.g. between the first and second stake, different cross-sectional profiles.

By way of example, the stakes may have as a round profile an outer diameter between 4 mm and 20 mm, preferably between 5 mm and 10 mm, more preferably 6 mm.

In some embodiments, the stakes are made of, or comprise, metal. The metal may be stainless steel, aluminum or another metal. The metal may be galvanized. The metal may be coated.

In some embodiments, the connecting element is made of plastic and/or of a composite material or comprises at least one of these materials.

In some embodiments, the connecting element comprises, as an example of a connecting device, a screw-nut arrangement and/or a clamp or quick-clamp device for the force-closure fastening of the stakes by the connecting element.

A clamp may be denoted as a quick-clamp device.

A clamp may be a clamp device which can be released or tightened or securely fastened quickly and optionally by hand without tools.

Purely exemplarily, the screw-nut arrangement or the clamp may have a total length of between 20 mm and 40 mm, preferably between 20 mm and 30 mm, more preferably ca. 25 mm.

In some embodiments, the stakes are straight along their entire longitudinal extent or only along a portion thereof.

In some embodiments, the stakes are curved along their entire longitudinal extent or only along a portion thereof.

Depending on the design of the stakes, whether straight or bent, the connecting element may comprise corresponding receptacles or receiving sections for the respective stake form.

In some embodiments, the plant support system comprises at least one holding device for fastening the plant support system to a vertical surface, for example a wall.

In several embodiments, the connecting element, as described herein, is designed to be fastened to the wall or to another location by a holding device (e.g. screw, dowel, etc.). For this purpose, the connecting device may be designed to be long enough in order, for example when it is a screw, to be inserted into the wall. The connecting device may for this purpose be designed as a screw, which passes through the connecting element and which, instead of being screwed with a conventional nut for clamping the stake, may be screwed into a long screw with end-thread or a long nut in order to be anchored with its end-side spiral section again, for example by a dowel, e.g. into a wall. The long screw with end-thread or the long nut may in turn be connected to the wall before being connected to the connecting device. In this way, it is possible to save material. In addition, the operational step of screwing the screw guided through the through-opening in the possibly narrow space between the rear side of the connecting element and a house wall, onto which the plant support system is provided, may be significantly facilitated.

In some embodiments, the connecting device comprises a long nut or a nut which has two respective end-side or front-side inner threads.

The holding device may be a pipe clamp or a clamp, a plug-in screw or another holding device. A plug-in screw may be fixed in the wall optionally by a dowel.

In several embodiments, the connecting element as described herein is not designed to be fastened to the wall or to another location by a holding device (e.g. screw, dowel, etc.). Connecting elements, which do not serve for fixing the plant support system to a wall or to another, mostly vertical, surface, have the advantage of being freely movable within the plant support system. If the plant grows e.g. further to the right and towards the top, then a connecting element, which needs not to ensure a fastening e.g. to the wall, may be provided in a right-hand area of the plant support system at a stake (as first stake) of the plant support system and in this a further stake (as second stake) may be inserted and clamped, screwed etc. The freely selectable position of a connecting element of this design may be of advantage even after the plant support system has been fastened e.g. to the wall in another way. Since such a connecting device requires no holding device for fastening it to the wall, the holding device may advantageously be omitted.

Holding devices may also be omitted when the plant support system is to be used standing freely (i.e. without support on or to e.g. a wall).

In some embodiments, the plant support system comprises a ground-fixing device for fastening the plant support system in a ground.

The ground-fixing device may be a tapered section with which at least one of the stakes or another portion of the plant support system may be inserted into the ground, for example the soil.

In some embodiments, the stakes, with respect to their longitudinal direction, are steplessly alignable by the connecting element at an angle between 0 degrees and 90 degrees or more (up to 360 degrees). This adjustability may relate to the angle that exists between two stakes that are connected to each other by the same connecting element. The angle may be determined in the area of the connecting element.

In some embodiments, the plant support system comprises at least one device (or more, for example one per connecting element) for holding a predetermined distance between the plant support system and a plane, for instance a house wall. The device may be connected to one of the connecting elements.

In some embodiments, the plant support system comprises at least one such device for holding designed as a sleeve, for instance, for guiding a fastening screw for fastening the plant support system.

What is herein stated about a connecting element, relates or applies to connecting elements which are part of the plant support system according to the present invention, and applies as well undiminished to connecting elements according to the present invention which are not or not yet part of such a plant support system. In order to avoid repetitions, there will be no repeated disclosure, with respect to the connecting element according to the present invention, to what has been disclosed about connecting elements of the plant support system.

Some or all of the embodiments may have one or several of the above-mentioned or following advantages.

The plant support system according to the present invention may advantageously be adapted to the new height or shape during the growing of the supported plant. The stakes may be changed in their position and arrangement within the plant support system by the releasable connecting elements, so that for example a stake may be guided in a direction in which the plant has grown during growth. It is advantageous, that there is no need to change the entire plant support system in order to adapt to a growth of the plant, rather single parts thereof are individually and flexibly adaptable.

The plant support system according to the present invention may be advantageously adapted to a desired plant growth. If, for example, individual plant shoots are to grow in a certain direction, for example in order to achieve a specific pattern or plant cover on a house wall, this may be carried out advantageously simply and flexibly by the plant support system according to the present invention. Advantageously, single stakes and/or connecting elements may be moved or changed without having to adapt the entire plant support system.

The plant support system according to the present invention may advantageously be extended individually and flexibly. Single stakes and/or connecting elements may be adapted to end areas or corners or to an inner area of the plant support system without having to adapt the entire plant support system. By additional connecting elements, further stakes may be mounted or clamped to the existing plant support system.

The plant support system according to the present invention advantageously makes it possible to exchange single stakes and/or connecting elements, for example if single parts have been damaged, warped or altered in another way, intentionally or unintentionally. The replacement of single stakes and/or connecting elements may be done without having to disassemble the entire plant support system.

The plant support system according to the present invention is advantageously modular. Single modules, which include in particular the stakes and the connecting elements, may be exchanged or adapted and extended to the existing and assembled system. The modular design may thus allow a constant extension and practically a growth of the plant support system corresponding to the growth of the supported plant.

The present invention is exemplarily explained below with regard to the accompanying drawings in which identical reference numerals refer to the same or similar components. The following applies in the partly highly simplified figures:

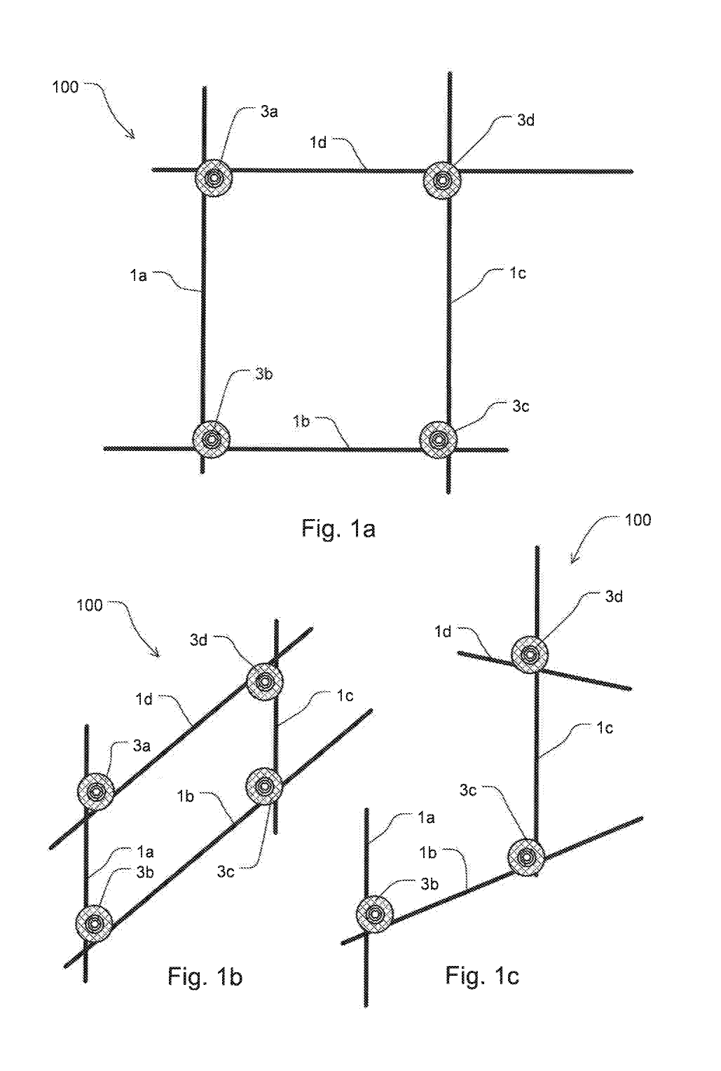

FIG. 1a,b,c show a plant support system according to the present invention with stakes and connecting elements in different arrangements;

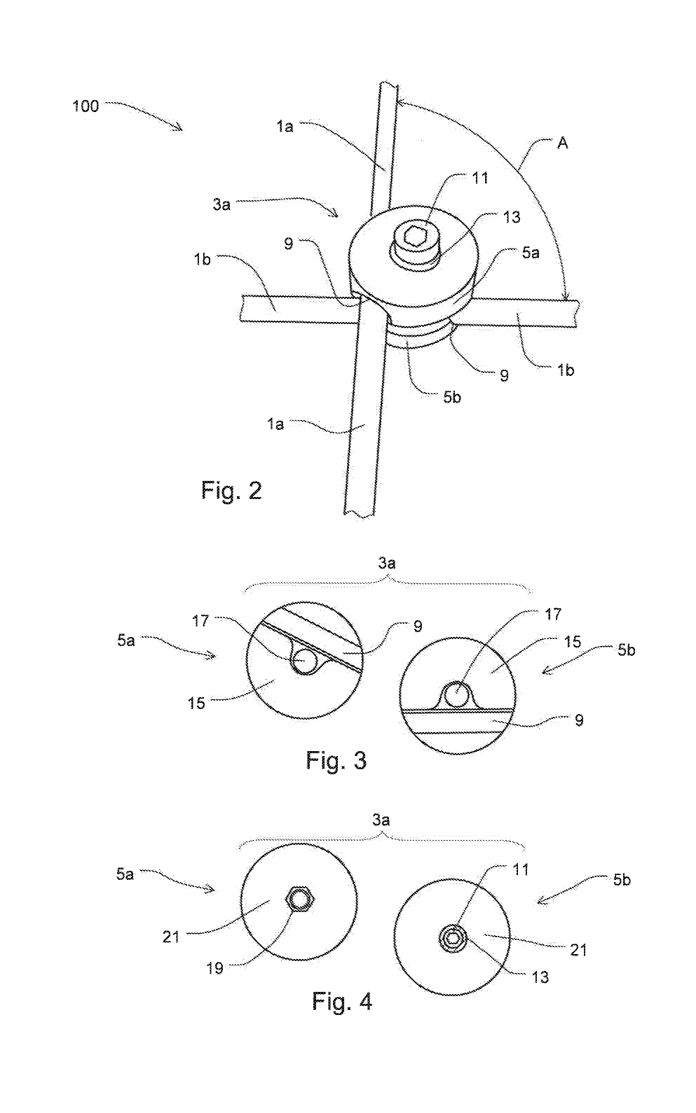

FIG. 2 shows the plant support system according to the present invention with a first and a second stake as well as a connecting element in a perspective view;

FIG. 3 shows the inner sides of two disc-shaped elements of the connecting element;

FIG. 4 shows the outer sides of two disc-shaped elements of the connecting element with a screwed connection;

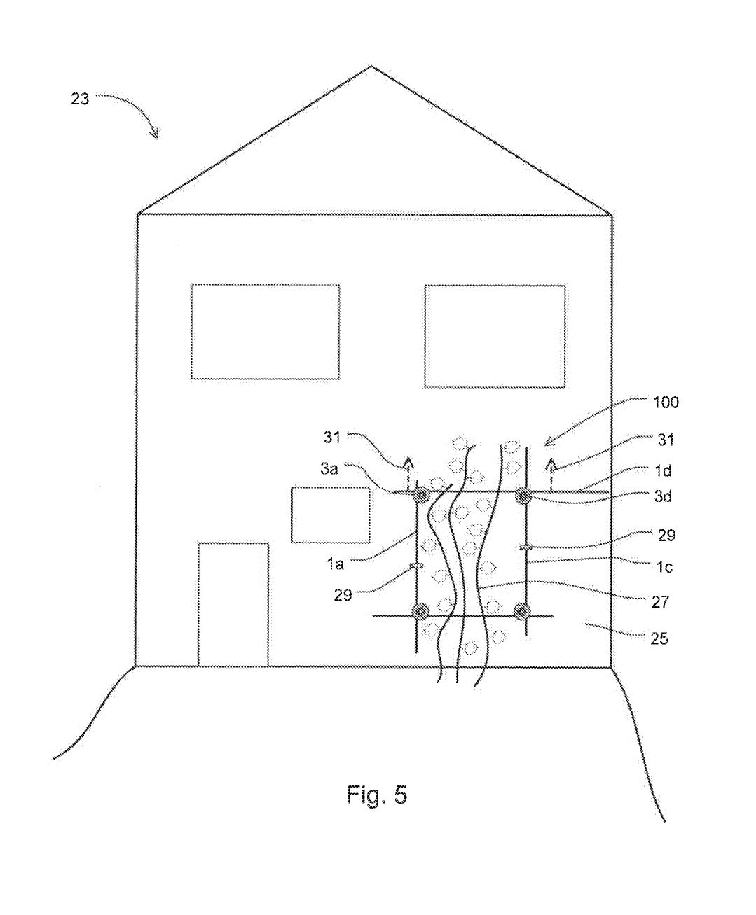

FIG. 5 shows plant support system according to the present invention from FIG. 1 with two holding devices, which are fastened to a house wall; and

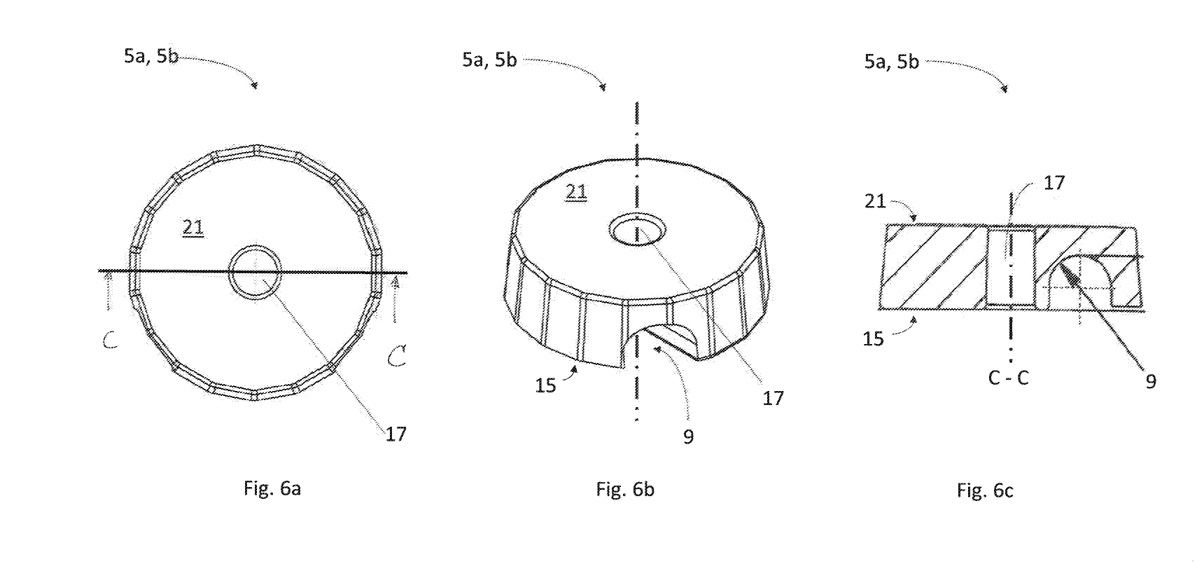

FIG. 6a,b,c show a disc-shaped element of a connecting element according to the present invention in three different views.

FIG. 1a shows a plant support system 100 according to the present invention with, purely exemplary, four stakes 1a, 1b, 1c, 1d and four connecting elements 3a, 3b, 3c, 3d.

The plant support system 100 is illustrated in an assembled state, in which each connecting element 3a, 3b, 3c, 3d is optionally connected with exactly two stakes 1a, 1b, 1c, 1d. By each of the releasable connecting elements 3a, 3b, 3c, 3d sections of exactly two stakes 1a, 1b, 1c, 1d are clamped. The clamping takes place in this exemplary embodiment by a screw-nut connection purely by way of example.

The stakes 1a, 1b, 1c, 1d are purely exemplarily arranged perpendicular to each other. The plant support system 100 according to the present invention allows however also other angular arrangements, as shown in FIG. 1b and FIG. 1c.

The four connecting elements 3a, 3b, 3c, 3d are arranged on the inside regarding the rectangle or square spanned by the stakes 1a, 1b, 1c, 1d. Alternatively, individual, several or all connecting elements 3a, 3b, 3c, 3d may be arranged in another quadrant of the respective crossing points.

Plants or plant shoots, which are not illustrated in FIG. 1a (see therefore FIG. 5), may be attached at the individual stakes 1a, 1b, 1c, 1d, for example by clips provided for this, by tapes or by other means. As the plant grows, for example the position of the stake 1d may be adapted by loosening the screw-nut connection of the connecting elements 3a and 3d, then moving the stake 1d upwards (referring to the illustration in FIG. 1a) and subsequently re-tightening the screw-nut connection of the connection elements 3a and 3d. If it is desired that the plant grows in a certain direction, then the stake 1d may be arranged at an angle other than the one shown in FIG. 1. Additionally or alternatively, it may be moved in its longitudinal direction and then be clamped again by the connecting elements 3a and 3d.

FIG. 1b shows the plant support system 100 according to the present invention of FIG. 1a in another arrangement. The rhomboid arrangement may be achieved by simple loosening of the respective screw-nut connections of the connecting elements 3a, 3b, 3c, 3d; starting e.g. with the arrangement. of FIG. 1a, by a subsequent arranging or rotating and/or moving of the stakes 1a, 1b, 1c, 1d as desired and by a subsequent retightening of the screw-nut connection.

Such a change of the arrangement of the stakes 1a, 1b, 1c, 1d is also possible after fastening plants or plant shoots, for example, for changing, correcting or realigning the direction of the plant growth. This may be done by moving one of the connecting elements along one of the stakes.

FIG. 1c shows the plant support system 100 according to the present invention of FIGS. 1a and 1b in a further arrangement.

The connecting element 3a has been removed for the sake of the arrangement in FIG. 1c, because the stake arrangement no longer provides or allows this crossing point of the stakes 1a and 1d. For example, one or several further stakes may be arranged at the right end areas of the stakes 1b and 1d, which may then be then be fastened or clamped by respective connecting elements that are not shown here. In this way, the plant growth may be individually influenced and aligned.

FIG. 2 shows the plant support system 100, or parts thereof, having the first stake 1a and the second stake 1b and the connecting element 3a in a perspective view. The connecting element 3a comprises an upper disc-shaped element 5a, and a lower disc-shaped element 5b. The disc-shaped elements 5a, 5b are for simplicity reasons referred to hereafter, as well as further supra, as discs 5a, 5b, wherein the elements 5a, 5b may basically be embodied also in other forms other than herein illustrated as round discs. For example, the discs 5a, 5b may be embodied as brackets with a pivotable clamping lever, as quick-release clamp or in a different way.

The inner sides 15 (see FIG. 3) of the discs 5a, 5b correspondingly maps the outer profile of the stakes 1a, 1b in sections. This mapping 9 may be referred to as recess 9. The stakes 1a, 1b are inserted or pressed into these recesses 9 and, before the discs 5a, 5b are firmly clamped or pressed against each other, they may be guided in order to, for example, be adapted in their longitudinal direction according to a desired plant growth direction.

Depending on the surface condition of the stakes 1a, 1b and/or of the recess 9 of the disc material, this frictional resistance may be selected or determined. For example, too smooth surfaces may be undesirable because the stakes 1a, 1b may shift unintentionally or may even slip out of the disc 5a, 5b.

Prior to firmly clamping the discs 5a, 5b against each other, the angle A of the stakes 1a, 1b towards each other may be varied and adjusted. The angle A may for example be continuously variable between 0 degrees and 180 degrees or up to 360 degrees.

The discs 5a, 5b are in this embodiment exemplarily clamped or fastened against each other by a screw-nut connection. In FIG. 2, the screw head 11 and an optional washer 13 can be seen. The screw is exemplarily designed as a hexagon socket screw. On the bottom of the lower disc 5b, the screw may be fastened by a nut 19 and an optional further washer.

In this, the screw head 11 or the nut 19 may be rotationally fastened in one of the discs 5a, 5b. This makes it possible to effect the clamping action using one tool. A countering with a second tool to prevent co-rotation of the screw head 11 or the nut 19 may advantageously be omitted.

FIG. 3 shows the inner sides 15 of two exemplarily designed disc-shaped elements 5a, 5b of the connecting elements 3a.

Exemplarily, the discs 5a, 5b are in this embodiment identical to each other or are structurally identical. This has the advantage that in the case of a plurality of connecting elements 3a, 3b, 3c, 3d for a plant support system 100 according to the present invention, the discs 5a, 5b do not have to be assigned in pairs. This advantage may be simpler and less expensive with respect to the production since for example only one injection molded form is required as an injection molded component. For assembling, identical discs 5a, 5b may save a considerable amount of time since no pairwise arrangements are necessary.

The recesses 9 are bowl-shaped recesses 9 (see FIG. 2), which receive the stakes 1a, 1b, 1c, 1d in sections. For example, the recesses 9 may receive or surround approximately half of the circumference of the stakes 1a, 1b, 1c, 1d.

The depth may alternatively be more than half, so that the stakes 1a, 1b, 1c, 1d are either pushed longitudinally into the recesses 9 or are inserted due to an elastic material of the discs 5a, 5b. This may be advantageous since the stakes 1a, 1b, 1c, 1d cannot slip out unintentionally. Likewise, the depth may be less than half of the circumference of the stakes 1a, 1b, 1c, 1d.

In FIG. 3, the through-openings 17 for the screw-nut connection are shown. These screws, or other connecting devices, may be guided through these through-openings. Another connecting device may for example be a so-called quick-clamp device. A quick-clamp device is a clamping device which may be released and tightened quickly by hand and optionally without using tools.

If herein a bore or a through-bore is mentioned, then the statements disclosed apply also to openings or through-openings. The use of the term “bore” is not intended to limit the way of creating the opening or the bore. The bore or the through-opening may, whenever mentioned herein, be rather molded or differently manufactured.

FIG. 4 shows the outer sides 21, more precisely the upper side 21 of two disc-shaped elements 5a, 5b of the connecting element 3a with a screw connection. The screw connection encompasses a screw, exemplarily designed as hexagon socket screw, with a screw head 11 and a nut 19. Optionally a washer 13 is arranged between the screw head 11 and the upper side 21 of the disc 5a. Optionally, a washer 14 may further be arranged between the nut 19 and the inner side 15 (bottom) of the disc 5a (not shown in FIG. 4).

Optionally, the nut 19 may be arranged in the disc 5a in form-fit connection. Thus, a rotation-proof may advantageously be achieved. The screw may be screwed to the nut and the connection element 3a may be clamped, without the need to hold or fasten the nut 19. This may be advantageous for assembling a plant support system 100 having numerous connecting elements 3a, 3b, 3c, 3d. However, the two discs 5a, 5b would not be then identical or structurally identical. The advantages of having discs 5a, 5b of identical structure have been already discussed (see above).

FIG. 5 shows a plant support system 100 according to the present invention of FIG. 1 having two holding sections 29 which are fastened to a house wall 25 of a house 23. Attached to the plant support system 100 is a plant 27 having plant shoots e.g. using plant clips or other fixings. When the plant 27 grows upwards along the house wall 25, for example, the upper stake 1d may be adapted to the plant growth in the arrow direction 31. This advantageously allows a directed and/or a stabilizing plant growth. In order to achieve a desired growth and a desired growth direction of the plant shoots, alternatively or additionally, the connecting elements 3a, 3d may be shifted along the stakes 1a, 1c, 1d upwards, downwards and/or laterally, after having loosened the clamping by the screw connection. In addition, the angles of the stakes 1a, 1c, 1d towards each other may be changed (see FIG. 1b and FIG. 1c).

The holding device 29 may be for example a pipe clamp or a clamp for fastening the stakes 1a, 1c to the house wall 25.

Optionally, the plant support system 100 according to the present invention may be fastened to a house wall 25 of a house 23, to a stone wall or to any other wall by one or several connecting elements 3a, 3b, 3c, 3d. In particular, this fastening may be achieved by one or several screws or screw connections which on the one hand fasten or clamp the disc-shaped elements 5a, 5b to the stakes 1a, 1b, 1c, 1d and on the other hand are or will be fixed into a house wall 25. The screws are then correspondingly long to bridge the distance between the plant support system 100 and the house wall 25. Such screws are, functionally speaking, holding devices simultaneously, as they have been previously described as separate components. In addition to these screws of the connecting elements 3a, 3b, 3c, 3d for the simultaneous fastening to a house wall 25, the plant support system 100 according to the present invention may comprise further connecting elements 3a, 3b, 3c, 3d which are not intended for being fastened to a house wall 25 and which are movable for example along one or several stakes 1a, 1b, 1c, 1d in order to be able to adapt the plant support system 100 to a plant growth.

Optionally, devices for retaining a certain distance between the plant support system 100 and the house wall 25 may be provided for the above-described fastening of the plant support system 100 to a house wall 25 using the connecting elements 3a, 3b, 3c, 3d. These may be for example screw sleeves with the length corresponding to the desired distance of the plant support system 100 to the house wall 25.

FIG. 6a shows a disc-shaped element 5a, 5b of a connecting element (e.g. 3a, 3b, 3c, 3d) in an exemplary embodiment from above. The view is directed to the outer side 21, here the surface, of the disc-shaped element 5a, 5b.

To be seen is a polygonal shape which purely exemplarily comprises 18 corners along its circumference. This may already be considered as round according to the present invention, especially since the corners are equally spaced apart and all corners have the same distance to the center of the disc-shaped element 5a, 5b. The center is indicated by a cross in FIG. 6a.

The middle region of the disc-shaped element 5a, 5b is herein exemplarily used for a through-bore or through-opening 17, which may optionally serve for receiving a screw or another connecting device.

It can further be seen in FIG. 6a that the disc-shaped element 5a, 5b comprises more than one radius. In the present embodiment, for example three radii are clearly recognizable. Two of them are also clearly recognizable from FIG. 6c. They may be caused by the optional trapezoidal shape of the disc-shaped element 5a, 5b in cross-section, see FIG. 6c.

FIG. 6b shows the disc-shaped element 5a, 5b of the FIG. 6a in a perspective view, obliquely from above.

For example, the corresponding form 9, here a recess or groove, herein exemplarily illustrated as a half-bowl shape, for receiving a round profile of a stakes 1a, 1b, 1c, 1d which is to be fastened (stake is not illustrated in the figure) is clearly seen. It may also be seen from the perspective view that the corresponding form 9, i.e. the groove or recess, does not extend through a middle region or through a central region of the main extension plane of the disc-shaped element 5a, 5b.

However, the previously-mentioned through-bore 17 is clearly seen in the middle region. Here, the middle region is optionally to be understood as a center of rotation of the disc-shaped element 5a, 5b, relative to the outer wall 21.

Furthermore, it can be clearly seen in FIG. 6b that for example the radius of the disc-shaped element 5a, 5b is smaller on the outer side 21 (upper side) than on the inner side 15 (lower side).

If two disc-shaped elements 5a, 5b are brought into contact with each other each by its inner side 15, then the contact plane of the two inner sides 15 represents their connection surface.

If two disc-shaped elements 5a, 5b are brought into contact with each other each by its inner side 15, then there is optionally a direct contact of the surfaces of the stakes, not shown in FIG. 6b, which stakes project beyond the inner side 15 of the disc-shaped elements 5a, 5b (in FIG. 6b, downwardly). If the two disc-shaped elements 5a, 5b are further pressed against each other, the stakes are pressed into the corresponding form of the discs or are clamped against each other and thus blocked or secured against a longitudinal movement of the stakes. several embodiments, the stakes are designed in their diameters to protrude or project over the contact plane which is formed by the two inner sides 15.

FIG. 6c shows the disc-shaped element 5a, 5b of the FIG. 6a in a cross-section along the axis C-C of FIG. 6a.

The above statements on the position and size of the through-bore 17, the corresponding form 9 of a stake section and the radii of the disc-shaped element 5a, 5b are again made clear here. Reference is made to the above figure descriptions to avoid duplication.

### LIST OF REFERENCE NUMERALS

100 plant support system
A angle of the stakes towards each other
1a, 1b, 1c, 1d stake
3a, 3b, 3c, 3d connecting element
5a, 5b disc-shaped element; disc
9 ; corresponding shape or form; recess or deepening
11 screw head
13 washer
15 inner side
17 through-opening
19 nut (of the screw or screw connection)
21 outer side
23 house
23 house wall, wall
27 plant; plant shoots
29 holding device
31 plant growth direction; arrow direction

1. A plant support system comprising at least a first stake and a second stake for supporting at least one plant thereon, as well as a connecting element for releasably connecting the two stakes to each other, wherein the connecting element is movable along the first stake and along the second stake.

2. The plant support system according to claim 1, wherein the connecting element comprises a clamping system for fastening, in particular releasably, the stakes to the connecting element in a force closure and/or form-fit connection.

3. The plant support system according to claim 1, wherein the connecting element surrounds the at least two stakes each completely at least in sections thereof and may be fastened by a clamping system.

4. The plant support system according to claim 1, wherein the connecting element comprises two disc-shaped elements, each of which correspondingly reflects at least partially the outer profile of the stakes on its inner side or has a receptacle thereto.

5. The plant support system according to claim 4, wherein the connecting element comprises two identical disc-shaped elements.

6. The plant support system according to claim 4, wherein each inner side of the disc-shaped elements correspondingly reflects the outer profile of one of the two stakes, at least in sections.

7. The plant support system according to claim 4, wherein each of the inner sides of the disc-shaped elements correspondingly reflects the outer profile of one of the two stakes, at least partially, so that one stake may be fastened using frictional connection for a force closure between an area of the inner side and an area of a surface of a further stake, respectively.

8. The plant support system according to claim 1, wherein the stakes have a tubular round profile and/or a tubular rectangular profile.

9. The plant support system according to claim 1, wherein the stakes are made of metal or comprise metal.

10. The plant support system according to claim 1, wherein the connecting element is made of plastic and/or of composite material or comprises at least one of these materials.

11. The plant support system according to claim 1, wherein the connecting element comprises a screw-nut arrangement or a clamp for fastening the stakes by the connecting element in a force closure connection.

12. The plant support system according to claim 1, wherein the stakes are straight and/or bent in their longitudinal direction.

13. The plant support system according to claim 1, wherein the plant support system comprises at least one holding device for fastening the plant support system to a surface or a vertical surface, like a wall.

14. The plant support system according to claim 1, wherein the stakes, in particular with respect to their longitudinal direction, are steplessly alignable by the connecting element in an angle between 0 degrees and 180 degrees.

15. A connecting element for releasably connecting at least a first stake and a second stake in order to assemble a plant support system for supporting at least one plant.
